(19) United States
(12) Patent Application Publication
(10) Pub. No.: US 2006/0246788 A1
(43) Pub. Date: Nov. 2, 2006

(54) Method for representing connections for validation during an automated configuration of a product

(75) Inventors: Douglas C. Ewing, Cedar Park, TX (US); Anand Raghavan, Austin, TX (US); James M. Vinson, Cedar Park, TX (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/116,588

(22) Filed: Apr. 28, 2005

(51) Int. Cl. G06F 13/00

(52) U.S. Cl. 439/894; 710/104

(57) ABSTRACT

A method, system, and computer-readable medium for representing connections in a computer system are provided. A component object representing a component in the computer system and a connection requesting object representing a connection to the component are instantiated. A type of resource for the component object is requested, wherein the connection requesting object transmits the request to a connection providing object, the connection object providing two or more resources. If one of the provided two or more resources is of a same type of resource as the requested type of resource and if the respective one of the provided two or more resources is available for consumption, the respective one of the two or more resources is consumed.

### CROSS-REFERENCE TO RELATED APPLICATIONS

This application is related to commonly-owned U.S. patent application entitled “Method to Establish Contexts for Use During Automated Product Configuration”, filed herewith (Atty Docket ROC920050085US1), which is herein incorporated by reference.

### BACKGROUND OF THE INVENTION

1. Field of the Invention

The present invention generally relates to a method, system, and computer-readable medium for representing physical connections during configuration of a product.

2. Description of the Related Art

Providers of high-end computer systems typically use a highly complex configuration system to configure a computer system to a customer's specifications. The configuration system includes a user interface that provides access to products data. Through the user interface, an operator selects a base system (e.g., a server model) and is then presented with configurable options which may be selected to be added to the selected base system. For a given set of operator selections, the configuration system determines whether the selections define a valid configured system. That is, the configuration system determines whether the operator selections are compatible and complete. If so, the configuration process is complete and, in some cases, additional steps such as, configuration validation, availability check, and the like are performed before the configured system is put into the order processing system.

Conventional configuration systems for computer systems are highly complex. A computer system output by a configuration system represents a valid state the determination of which depends upon a set of applicable part rules and part data. To validate a configuration, the applicable part rules and part data may be applied to a model of the system being configured. The process of applying part rules and part data to a model of a system may be referred to as validation. Examples of computer system configuration and validation are provided in U.S. Pat. No. 5,515,524, entitled “Method and Apparatus for Configuring Systems”, which is hereby incorporated by reference in its entirety.

In general, any model that is closest to the physical reality is a superior model for validating a given configuration. Thus, for each physical part in the configuration, a corresponding model part may be inserted in the system model. In addition, each physical part may be interconnected with other parts in the configuration. To represent the interconnections for each part, one or more other model elements, referred to as ports (or connections) may be added to the model. Each model part and its associated ports may be used during validation to verify that valid connections between parts exist.

A part with multiple port elements may be used to create a series of connections, referred to as a connection chain, within the model. FIG. 1 is a block diagram depicting a connection chain 100 according to prior art. The connection chain 100 may contain a first part 102 with an associated port 104. The first port 104 may provide a single connection to a port 112 for a second object 110. Another port 114 on the second object 110 may provide a single connection to a port 122 on a third object 120. Such a connection chain 100 may represent, for instance, a hard drive (first part 102) connected to a backplane (second part 110) which is in turn connected to a disk controller (third part 120).

To establish a connection for a part 102, a configuration system may look for available connections on another part such as the second part 110. Once an available connection is found, a connection between the ports 104, 112 on each part may be recorded in a master list of connections maintained by the configuration system. Creating the connection may only require that the connection types of each port 104, 112 be examined to determine if they are compatible. Similar steps may be used to connect the second part 110 to the third part 120. When each of the connections in a system is only recorded in a master list, each port may have no record of what connection exists between it and other ports. Because each port may not contain a record of its connection, the port may have limited utility during any later validation where the port is used. Also, because the configuration system establishes the connection, connection choices are limited to those provided by the configuration system. For a specific part with special connection requirements, the configuration system may have no way of choosing an optimum connection for such a part.

In addition to requiring a connection, the first part 102 may need functionality provided by the third part 120 to operate properly. Thus, the first part 102 may be said to require a resource from the third part 120 to perform properly. Where the first part 102 represents a disk drive and the third part 120 represents a disk controller, the disk drive may require disk controller access to an appropriate type of disk controller. As an example, the disk drive may be a Small Computer System Interface disk drive (a SCSI drive). The SCSI drive may require a matching resource from a SCSI disk controller. In the underlying model, the port 122 for the SCSI device may only provide a single SCSI resource.

The single SCSI resource may be provided to an intermediate part, such as the backplane (the second part 110). The backplane may consume the single SCSI resource from the SCSI disk controller. Because the port 114 with the connection to the part 120 providing the resource is modeled as a different entity from port 112 connected to the part 102 needing the resource, special code within the configuration system may be required which transfers the resource received by the first port 112 to the second port 114. Thus, each time a new type of transfer is modeled, the transfer code may need to be modified and rewritten to support the new transfer. Thus, modeling resource transfers using transfer code may be inflexible.

In some cases, the described resource allocation and consumption may not accurately model the physical reality. For instance, a single physical part may be capable of providing multiple resources, and another part may similarly consume multiple resources. These resources may be provided across a single connection or across multiple connections. The system model described above may only allow a single resource to be transferred across a modeled connection, and thus may not mirror the physical reality. In addition, some physical parts such as a backplane may accept a resource and provide a multiple number of that resource to other parts. Thus, a physical backplane may be used to create a connection tree in a computer system, as opposed to a connection chain. The model described above with respect to FIG. 1 does not provide the ability to create connection trees in such a system.

The resource allocation of the prior art also fails to provide for more complex types of resource matching. For instance, a SCSI disk controller may provide a type of resource such as an Ultra320 SCSI resource. The Ultra320 SCSI resource may be an improved resource over another type of resource such an Ultra3 SCSI resource or an Ultra2 SCSI resource. Despite being an improved version, the Ultra320 SCSI resource may be downwards or backwards compatible with the Ultra3 SCSI resource and the Ultra2 SCSI resource. However, the above described configuration system does not recognize and utilize such relationships between each of the related resources.

Thus, as described, the current methods for creating and representing connections in a computer system model are inflexible and may not accurately describe the underlying physical realities of the system being modeled. Therefore, there is a need for improved methods for representing connections in a computer system.

### SUMMARY OF THE INVENTION

Embodiments of the present invention provide a method, system, and computer-readable medium for representing connections in a computer system. A component object representing a component in the computer system is instantiated and a connection requesting object representing a connection to the component is instantiated. A type of resource for the component object is requested, wherein the connection requesting object transmits the request to a connection providing object, the connection object providing two or more resources. If one of the provided two or more resources is of a same type of resource as the requested type of resource and if the respective one of the provided two or more resources is available for consumption, the respective one of the two or more resources is consumed and the connection is created.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a block diagram depicting a connection chain according to prior art.

FIG. 2 is a high-level diagram of a configuration system in which aspects of the present invention may be implemented according to one embodiment of the invention.

FIG. 3 is a user interface screen illustrating generic configuration tool capabilities according to one embodiment of the present invention.

FIG. 4 is a user interface screen illustrating a messages tab in a generic configuration tool user interface screen according to one embodiment of the present invention.

FIG. 5 is a user interface screen illustrating selection and configuration of a product according to one embodiment of the present invention.

FIG. 6 is a user interface screen illustrating a diagram tab in a generic configuration tool user interface screen according to one embodiment of the present invention.

FIG. 7 is a user interface screen illustrating a configuration wizard for a product according to one embodiment of the present invention.

FIG. 8 is a user interface screen illustrating a modified products list according to one embodiment of the present invention.

FIG. 9 is a user interface screen illustrating a diagram pane showing the additional selected products according to one embodiment of the present invention.

FIG. 10 is a user interface screen illustrating a diagram pane showing the final configured system, according to one embodiment of the present invention.

FIG. 11 is a block diagram depicting a connection tree according to one embodiment of the present invention.

FIG. 12 is a block diagram depicting a connection object which both requests resources and provides resources according to one embodiment of the invention.

FIG. 13 is a block diagram depicting a connection tree which utilizes a connection object which both requests resources and provides resources according to one embodiment of the invention.

FIG. 14 is a flow diagram depicting a process for creating a connection utilizing a connection requesting object according to one embodiment of the invention.

FIG. 15 is a flow diagram depicting a process for creating a connection utilizing a connection providing object according to one embodiment of the invention.

FIG. 16 is a flow diagram depicting a process for creating a connection utilizing a connection object which both requests resources and provides resources according to one embodiment of the invention.

FIG. 17 is a block diagram depicting a model of a network of computers connected with connection objects according to one embodiment of the invention.

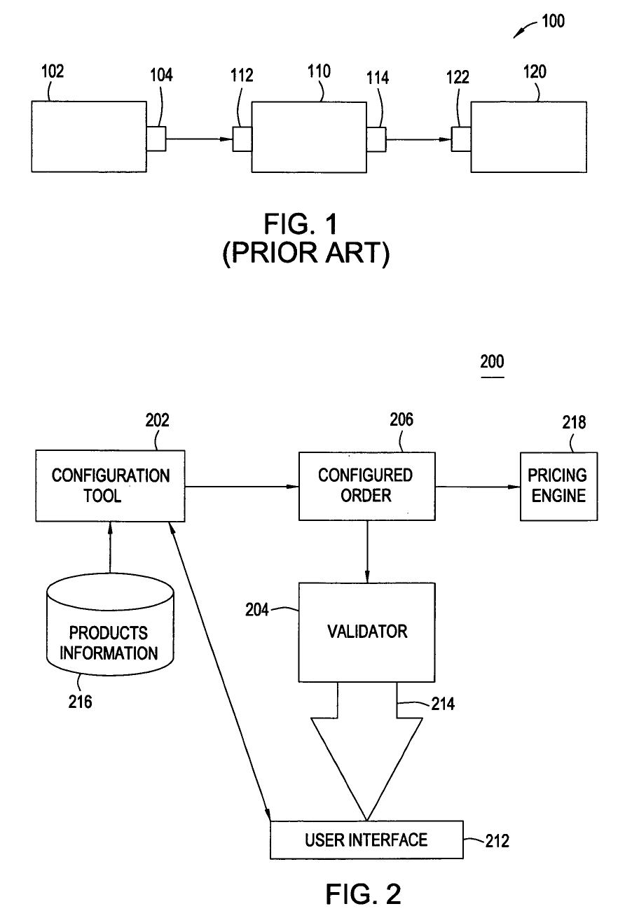

### DETAILED DESCRIPTION OF THE PREFERRED EMBODIMENTS

Embodiments of the present invention provide methods for representing connections in a computer system. One method generally includes instantiating a component object representing a component in the computer system and instantiating a connection requesting object representing a connection to the component. A type of resource for the component object is requested, wherein the connection requesting object transmits the request to a connection providing object, the connection providing object providing two or more resources. If one of the provided two or more resources is of the same type of resource as the requested type of resource and is available for consumption, the respective one of the two or more resources is consumed and the connection is created.

For purposes of illustration, aspects of the invention described herein are specifically directed to configuration systems used in configuring computer systems. Such computer systems may include personal computers, servers, clustered systems, computer networks or any other system of computers. However, it is understood that the invention includes, extends to, encompasses, and/or applies to any other system being configured. For example, the configuration system may be a system used to configure a telecommunications system, a mechanical system (e.g., an automobile), or any other type of system. Persons skilled in the art will recognize other environments which may benefit from aspects of the invention.

Also, various types of parts, connections, resources and other objects used in modeling systems are described below. The parts described may be any type of parts, including hardware and software parts. The connections may also be of any type, including physical hardware connections, software to software connections (e.g., through an API), software to hardware connections (e.g., through a device driver), wireless connections, or any other type of possible connection. Similarly, resources may represent any physical relationship (e.g., a drive bay may provide a drive space resource), functional relationship (e.g., a disk controller may provide functionality to a disk drive), or any other type of resource relationship. In general, embodiments of the invention may be used in various situations in which a system is modeled.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments, the invention provides numerous advantages over the prior art. However, although embodiments of the invention may achieve advantages over other possible solutions and/or over the prior art, whether a particular advantage is achieved by a given embodiment is not limiting of the invention. Thus, the following aspects, features, embodiments and advantages are merely illustrative and are not considered elements or limitations of the appended claims except where explicitly recited in a claim. Likewise, reference to “the invention” shall not be construed as a generalization of any inventive subject matter disclosed herein and shall not be considered to be an element or limitation of the appended claims except where explicitly recited in a claim.

One embodiment of the invention is implemented as a program product for use with a computer system. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Configuration System Overview

Referring now to FIG. 2, a configuration system 200 is shown. Generally, the system 200 includes a system configuration tool 202 and a validator 204. As shown in FIG. 2, the system 200 is not intended to suggest or necessitate any particular architecture. Thus, it is contemplated that the configuration tool 202 and the validator 204 reside on the same system, or on separate systems. Further, although shown as singular entities, in practice the configuration tool 202 and the validator 204 may be implemented as a plurality of software and/or hardware components collectively configured to perform various functions, including those described herein. Thus, in one embodiment, the configuration tool 202 may run on a desktop. In another embodiment, the configuration tool 202 may be run as a web application.

In an embodiment of the present invention, the configuration tool 202 provides a user access to available product selections from products information source 216. The available selections are displayed, and selected from, a user interface 212. In addition to data representing the available selections from which a user may choose, the products information source 216 may also include the necessary logic for these data to interact with each other and respond to different user selections. Once a configuration has been chosen using the configuration tool 202, the validator 204 may process the selections and determine whether the products chosen are compatible and complete to be a valid order, by running them through a validation logic/process.

In operation, the configuration tool 202 presents the available product selections to a user who then makes desired selections via the user interface 212. The result of each user selection is a configured order 206, produced by the configuration tool 202. Thus, the configuration tool 202 may iteratively output a configured order 206 in response to each user selection of a product. The configured order 206 represents a state of the configured system during the user selection process and contains a list of products selected and used in the configuration of the current system. Any given configured order, however, may not be valid.

At least in one embodiment, validation is performed in response to an explicit user command input via the user interface 212. In response to the validation request, the validator 204 determines, for the given set of user selections, whether the selections are compatible and result in a valid configured system. Upon successfully validating the configuration, the final configured system is in a single valid state. That is, all the necessary parts (i.e., hardware, software, services, etc) have been automatically generated and validated. The validator 204 may provide feedback 214 to the user interface 212 depending upon the success of the validation process. If the configured system is invalid, an error message may be shown to the user. The error message may, for instance, explain why the selected configuration is invalid or suggest alternative choices which may be valid. If the validation is successful, the feedback 214 may inform the user that the selected configuration is valid.

The configuration tool 202 may also be configured to determine availability of additional compatible products by examining the configured order 206 and a cross-sell information source. In one embodiment, the cross-sell information source contains cross-sell products that may be offered to customers who have configured a system, or are currently configuring a system, using the configuration tool 202.

At any time during configuration of a system (whether validated or not), a user may determine the price of selected components and the configured system by invoking a pricing engine 218. The pricing engine 218 includes pricing files that contain pricing data for corresponding products in the products information source 216. Once an order is configured (although not necessarily validated), the selected products list contained in the configured order 206 is received by the pricing engine. The pricing engine then, accesses the price data for the products in the order and calculates the final price.

Exemplary Configuration Process

As noted above, user interaction with the system 200 is facilitated by the interface 212. In one embodiment, the interface 212 is a graphical user interface (GUI) comprising a number of screens that enable the user to configure a system. The user steps taken with respect to the interface 212 during a configuration process may include, but are not limited to, making selections from a list of available products and services and configuring and validating the system based on the selections made. Following is an illustration of such steps with respect to representative screens of the interface 212.

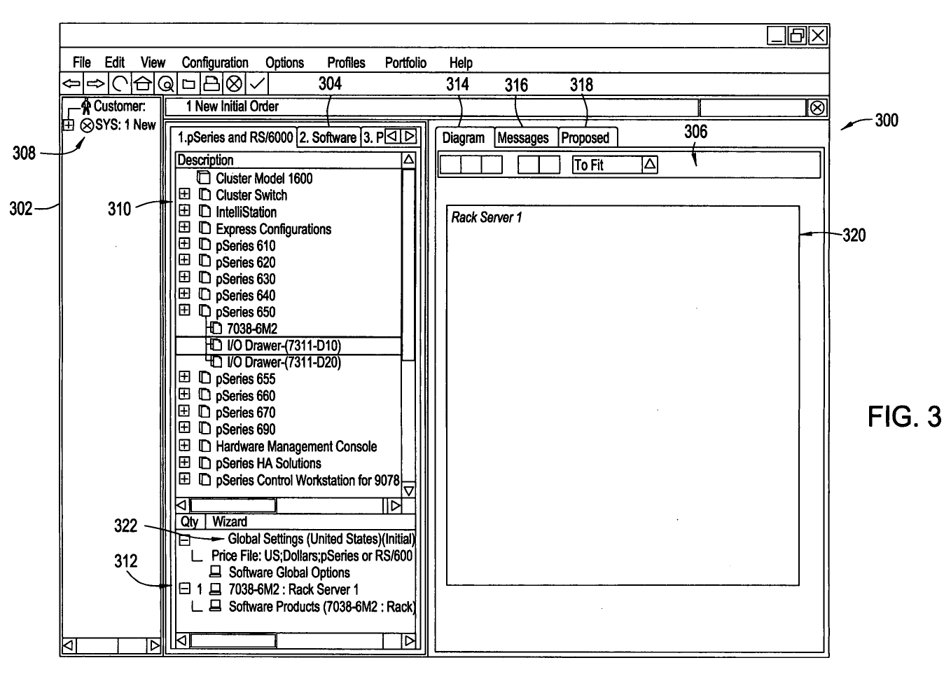

FIGS. 3-9 show exemplary user interface 312 screens that may be utilized in selecting products for and configuring a system according to one embodiment of the present invention. For example, FIG. 3 illustrates an exemplary GUI screen 300 through which a user can select configurable products for a previously chosen base system. The GUI screen 300 illustratively includes three frames. A first frame 302 presents a list of base systems a customer has ordered, showing whether those systems are in a valid state. For example, a red cross 308, signals that the base system, SYS: 1New, has not yet been validated. A second frame 304 is divided between two sections. A top section 310 includes various tabs that represent the different kinds of components available for the base system 308. By clicking on each of these tabs, the user may be presented with a comprehensive list of products available. A bottom section 312 shows a list of products that have already been selected. For example, the frame 312 shows that a rack server 7038-6M2 has previously been selected by the customer. Additionally, the bottom section 312 contains a Global Settings object 322. The object 322 represents the geographic context in which a system is being configured. For example, as illustrated, the Global Settings object 322 is set to the “United States”, since the product is being configured and sold in the United States. If the system were being configured in a Japan, for example, the object 322 would be set to Japan. For a given geographic context, the Global Settings object represents the available products, cross-sell products, and/or pricing files that are being used in the current configuration session.

In addition to the functionalities provided by the frame 304 (in the top and bottom sections 310 and 312), a third frame 306 on the right offers three additional tabs. Selection of a diagram tab 314 may show customer orders in a diagram pane diagram pane 320. The diagram pane 320 shows a top-level graphical representation of the ordered system. The details of the underlying structure of the ordered system, however, may be omitted from the diagram pane 320. Selection of a proposed tab 318 may present a list of products selected and their corresponding cost in a textual format. Additionally, selection of a messages tab 316 may provide a list of messages the provider wishes to convey to the customer.

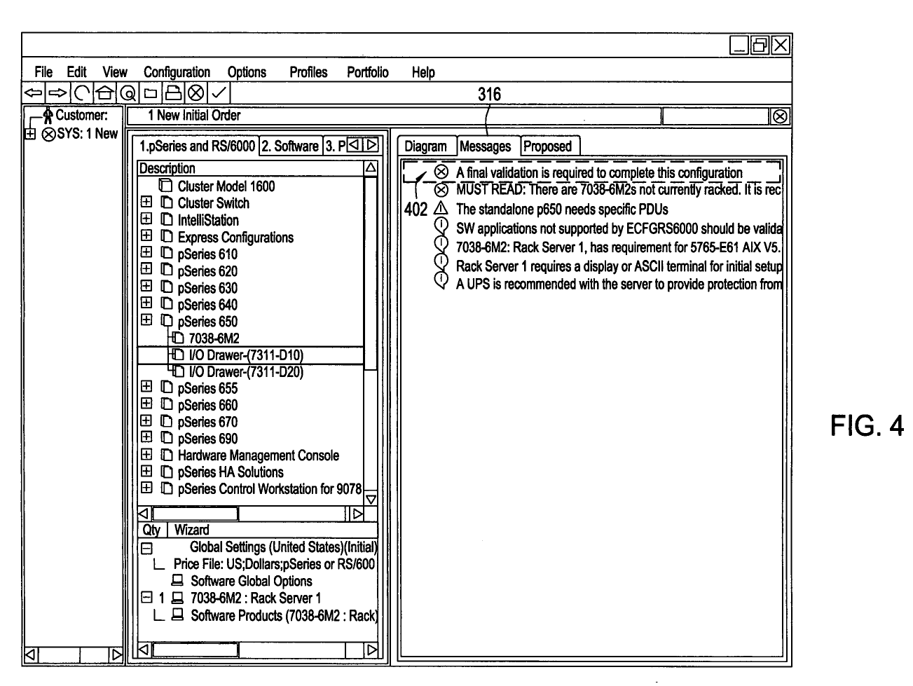

FIG. 4 illustrates representative messages that may be displayed to the user when the messages tab 316 is selected. For example, the messages include a warning 402: “A final validation is required to complete this configuration.”

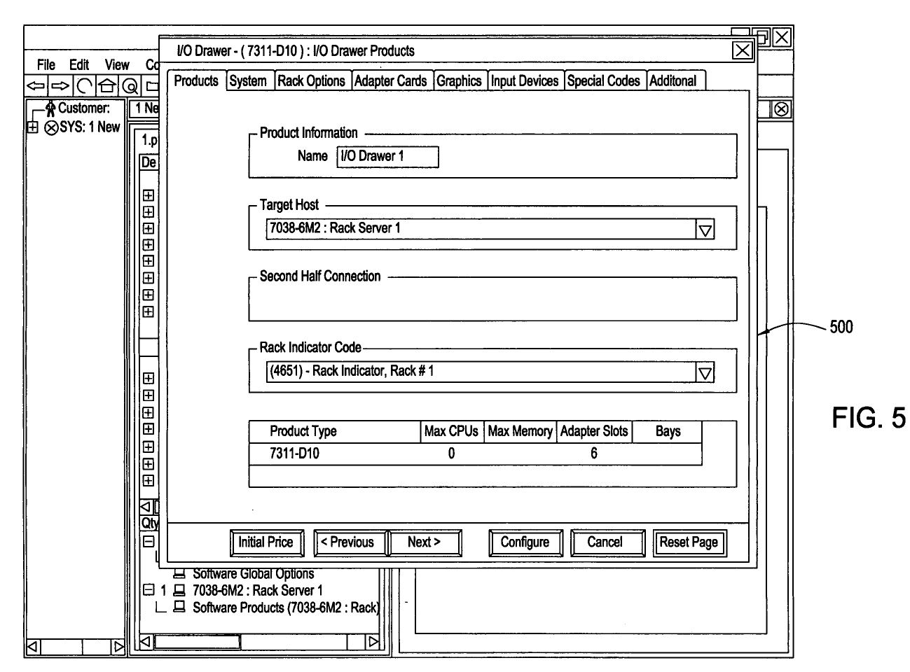

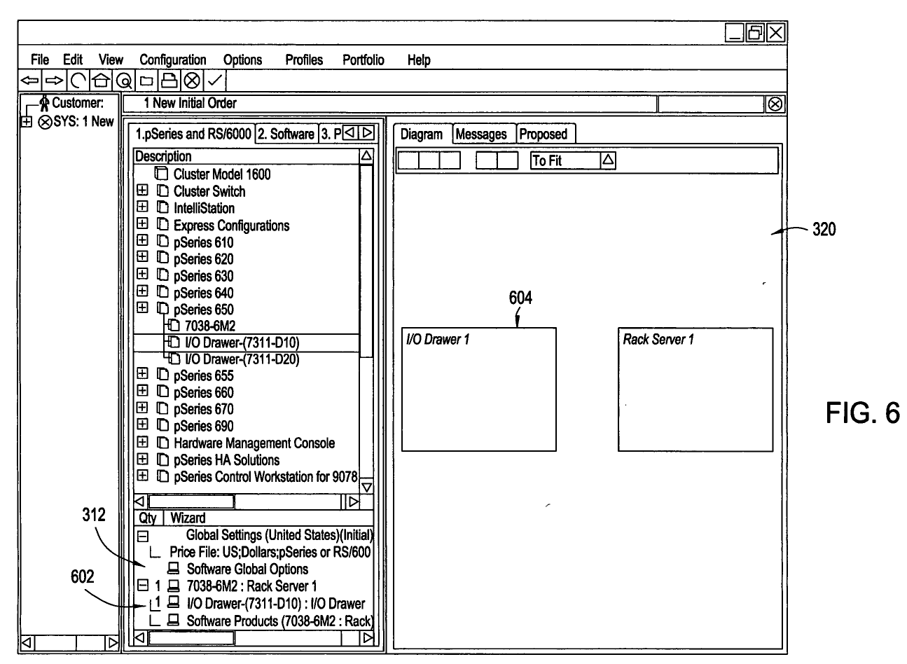

Selecting an additional product from the top section 310 may invoke a corresponding wizard that assists in customizing and configuring an available product. For example, by selecting “I/O Drawer-[7311-D10]” from the “pSeries and RS/6000” tab, a wizard such as the one illustrated in FIG. 5 may be invoked. As shown in an exemplary GUI 500, the user may utilize the wizard to customize the order, configure the system, or cancel the request. FIG. 6 illustrates that after the product has been selected and customized through the wizard, a product object 602 (“I/O Drawer”) is added to the products list in the frame 312. Additionally a graphical element 604 representing the “I/O Drawer” has been added to the diagram pane 320.

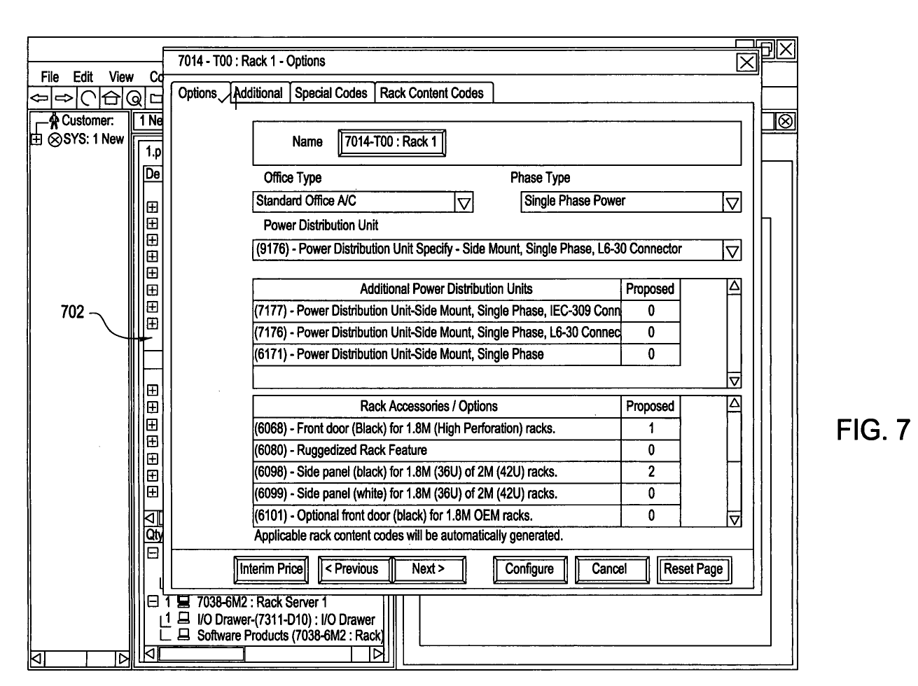

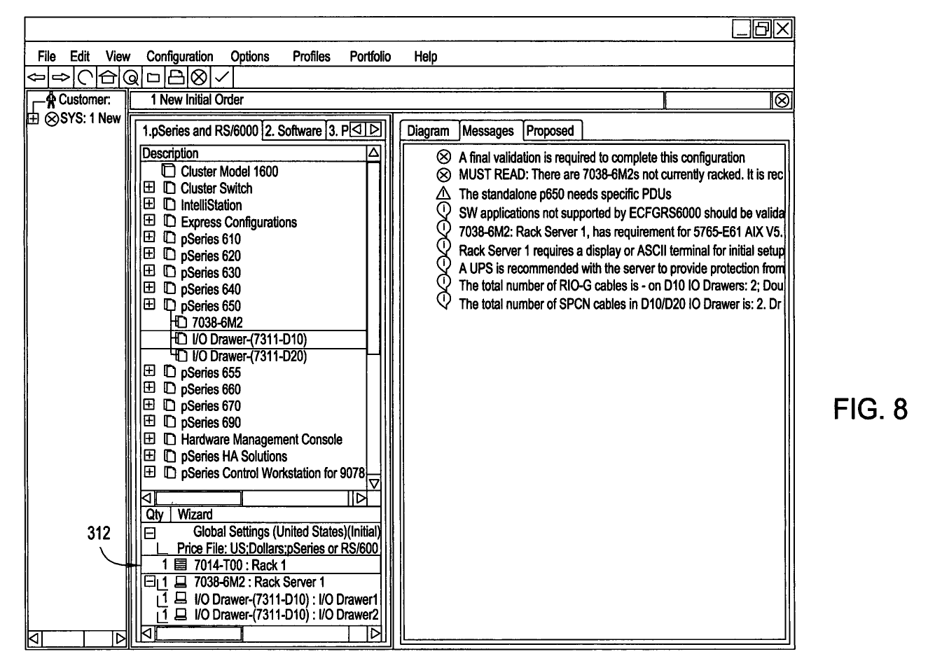

FIG. 7 is one embodiment of a user interface screen illustrating another configuration wizard for a product, according to one embodiment of the present invention. After a user has selected a new product, for instance a 7014-T00 Rack, a 7014-T00 Wizard may be launched. The user may customize the new selected product and reconfigure the system through the wizard 702, as shown in FIG. 7. FIG. 8 shows that the new product “7014-T00” has been added to the product's list in the frame 312.

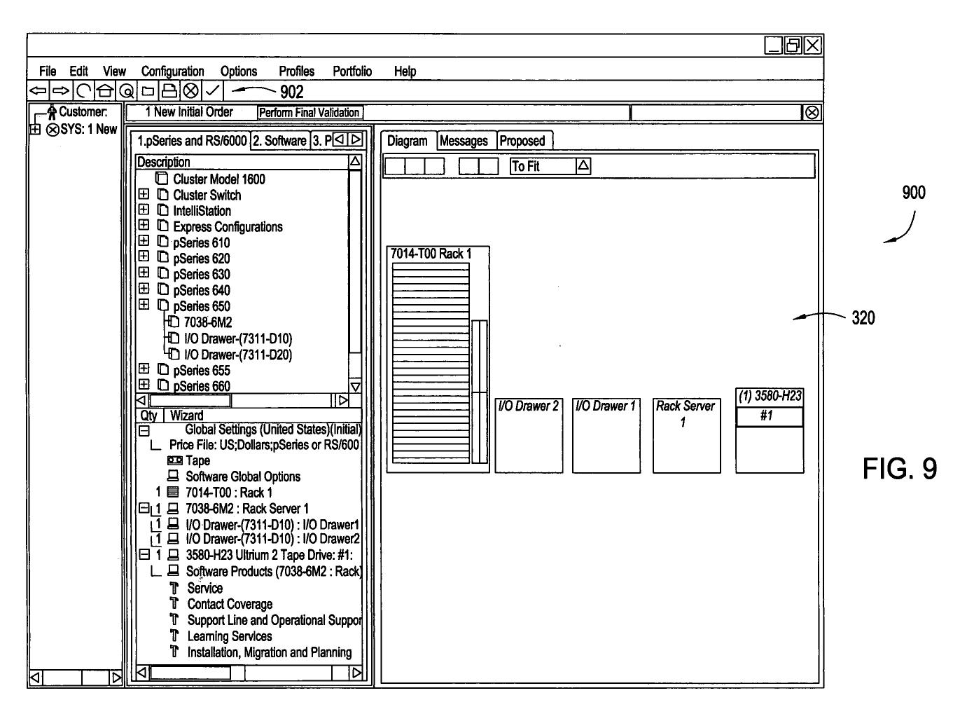

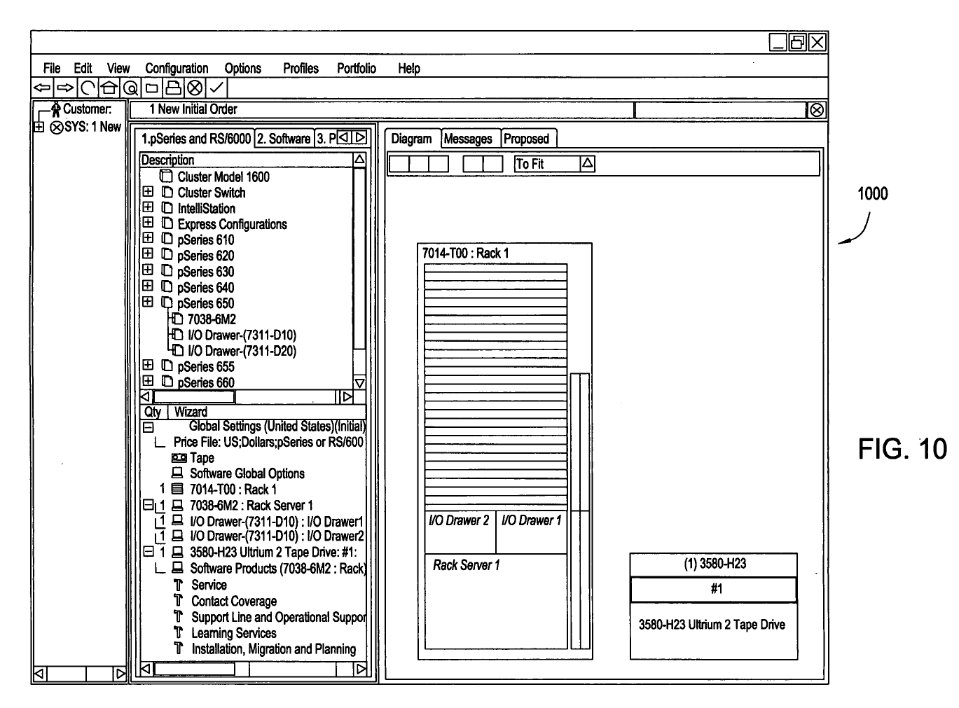

FIG. 9 is a user interface screen 900 illustrating the diagram pane 320, after the customer has selected and configured additional products for the system. As shown, a button 902 (marked by a checkmark) is provided for performing the final validation for the system. By clicking on the button 902 a final configuration for the system may be performed (described below). FIG. 10 is an exemplary GUI 1000 illustrating the final configured system. As illustrated, the different components are now organized and stacked to represent a final valid state.

While the GUI screens described herein provide one or more embodiments of the present invention, persons skilled in the art will recognize that the information presented herein can be presented in a variety of other ways while still providing the same or similar results.

Representing Connections Within the Configuration Model

When a request to validate a user-configured computer system is received (e.g., when the user presses button 902), a model representing the configured computer system may be created for use in the validation process. In one embodiment, the validation process may be performed by the validator 204. Creating the system model for using in validation may include inserting model elements into the system model. Each model element may correspond to physical parts in the computer system being configured. As each element is inserted into the model, the inserted element may be validated. As described previously, validating an element may include using part rules and part data for the element to determine if the element is compatible with the other elements in the model.

According to one embodiment of the invention, elements inserted into the model may be implemented as objects having associated member functions and member data. The implemented object for a component or part may be referred to as a component object or part object. For each component in a system, a component class which describes the component may be provided, and the component object may be instantiated using the class. For related components, one component class may be derived from another related component class.

Embodiments of the present invention provide connection objects (also referred to as connections, ports, or port objects) which may be used to represent connections between component objects within the system model during the validation process. As used herein, the term connection object may refer to a needer port, provider port, or activator port. As described below, an activator port may act as a needer port or provider port. As such, the term needer port or the term provider port is synonymous with an activator port when the activator port is acting as the described port. In one embodiment of the present invention, a single port object may represent multiple connections to the port object, wherein each connection consumes one or more resources of the port object. Each type of connection object is described below in greater detail.

Connection Objects Which Request Resources

A needer port is a connection object which may be instantiated for an associated component object which needs resources to be properly validated. The component object may use the needer port to obtain one or more resources from another object providing resources. The needer port may be instantiated and inserted into the component object as an attribute of the component object. Each needer port may be used by the associated component object to request a specified number of resources. For instance, if the component object is a disk drive which needs power from a power supply, the needer port may be used to request a number of resources corresponding to the needed power. As another example, a disk drive may need an amount of bandwidth from an interface. Accordingly, the needer port for that object may request a number of resources corresponding to that bandwidth.

Various other aspects of needer ports are described below in greater detail with reference to creating and processing connections with other ports.

Connection Objects Which Provide Resources

A provider port is a connection object which provides one or more resources for an associated component object during the validation process. For example, a disk controller may provide access resources to a number of disk drives. Thus, a provider port for the disk controller object may provide a number of resources corresponding to the allowable access resources of the disk controller. As another example, a power supply may provide a certain amount of power. The provided power may be measured, for instance, in watts. A provider port for the power supply object may provide a number of resources corresponding to the number of watts provided by the power supply.

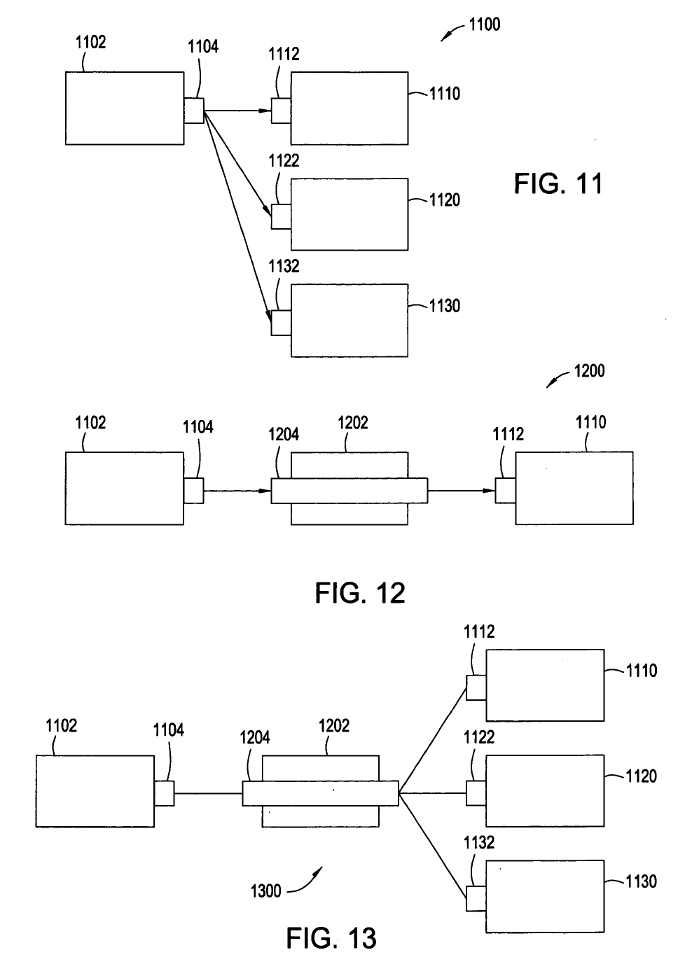

A provider port may be used to satisfy the resource needs of a needer port. Because a provider may provide multiple resources, multiple needer ports may be connected to a single provider port. Accordingly, a provider port may be used to create a connection tree. FIG. 11 is a block diagram depicting a connection tree according to one embodiment of the present invention. A first component object 1102 with a provider port 1104 providing multiple resources is depicted. The provider port 1104 may provide one or more resources to each of a first needer port 1112, a second needer port 1122, and a third needer port 1132. Each needer port 1112, 1122, 1132 may be associated with a respective corresponding object 1110, 1120, 1130, each of which consuming one or more resources through its associated needer port 1112, 1122, 1132.

According to one embodiment of the invention, the resources provided by the provider port may be hierarchical resources and may thus be hierarchically matched with resources requested by the needer ports. A hierarchical resource refers to a group of resources which are hierarchically related. As an example, an Ultra320 SCSI controller may be the newest and fastest SCSI controller. However, the Ultra320 SCSI controller may also allow older and slower disk drives, such as an Ultra3 SCSI drive or an Ultra2 SCSI drive, to connect to the controller. While the older Ultra3 SCSI and Ultra2 SCSI drives may be successfully connected and receive resources from the newer Ultra320 SCSI controller, the older drives may operate at a slower speed according to their type. A connection created with hierarchical resources may be referred to as a hierarchical connection.

According to one embodiment of the invention, the provider port may be configured to perform hierarchical resource provisioning and consumption. Thus, if a needer port requests a resource from a provider port, the provider port may first determine whether a perfectly matching resource is provided. If a perfectly matching resource is not provided, the provider port may determine if a hierarchical match can be made between the requested resource and the provided resource. If neither a perfect match nor a hierarchical match can be made, the provider port is not able to provide the requested resource. On the other hand, if either a perfect match or hierarchical match of resource types can be made, and if the provider port has the requested number of resources available for consumption, the resource may be provided to the requesting port.

In one embodiment, the hierarchical matching may be unidirectional. Unidirectional hierarchical resource matching may refer to a situation wherein the provided resource is hierarchically matched to the requested resource but the requested resource is not hierarchically matched to the provided resource. In other words, the provided resource may be broadly interpreted, but the requested resource may be narrowly interpreted (or vice versa). For instance, an Ultra320 SCSI drive may not be allowed to consume a resource from an Ultra2 SCSI controller, while an Ultra2 SCSI drive may be allowed to consume a resource from an Ultra320 SCSI controller. In the first case, the provided type of Ultra2 SCSI resource is not hierarchically mapped to the requested resource for the Ultra320 SCSI driver. In the second case, as described above, the provided type of Ultra320 SCSI resource is hierarchically mapped to the requested resource for the Ultra2 SCSI driver.

In another embodiment, the hierarchical matching may be bidirectional. Bidirectional hierarchical matching refers to the situation wherein both the requested resource and the provided resource are hierarchically matched. In other words, both the requested resource and the provided resource may be broadly interpreted. For instance, a USB 1.0 controller may be accessed by a USB 2.0 device and a USB 2.0 controller may be accessed by a USB 1.0 device. In either case, the access rate may be limited by the slower component out of the controller and the accessing device, but the connection may be allowed nonetheless.

Where a provider port provides multiple resources which may be consumed, the provider port may track resource consumption. For instance, if a provider port provides five resources, a first needer port may consume two of the resources and a second needer port may consume two of the resources. The provider port may track the number of available resources (five provided−four consumed=one available) for each of the ports. Thus, if the provider port subsequently receives a request for two of the appropriate type of resource, the provider port may reject the request. If the provider port receives an incoming request for one of the appropriate type of resource, the provider port may accept the request and allow the remaining resource to be consumed. The provider port may then record that no resources are available.

According to another embodiment of the invention, a parameter may also be used by the provider port to determine if resources provided by the provider port should not be consumed when a connection is made. For instance, the provider port may provide resources for a network interface component. Several needer ports for software components (e.g., web browsers, chat clients, web servers, e-mail clients, etc.) may each access a bandwidth resource provided by the network interface. Even though the bandwidth provided by the network interface may be limited, the bandwidth may be subdivided as many times as necessary to accommodate each component using the network interface. Accordingly, the parameter for the network interface provider port may indicate that the bandwidth resource provided by the port is not consumed, regardless of the number of connections to the provider port. As another example, several software components may require access to a CD-ROM drive. Each software component may share the CD-ROM drive, and thus the parameter for a provider port which provides the CD-ROM resource may indicate that the CD-ROM resource is not consumed. In hardware, a CPU may similarly be shared by each of the components within the system. Thus, a CPU resource provided by a CPU may not be consumed.

Various other aspects of provider ports are described below in greater detail with reference to creating and processing connections.

Connection Objects Which Request and Provide Resources

An activator port is a connection object which requests resources and also provides resources for an associated component object during the validation process. Thus, an activator port may either act as a needer port or a provider port depending on the context. An activator port may handle both incoming connections from connection requesting objects and may make outgoing connections to connection providing objects. Such connections may be managed completely by the connection object, without requiring external transfer logic (e.g., from the validator 204). FIG. 12 is a block diagram depicting a connection chain 1200 with an activator port 1204 which both requests resources and provides resources according to one embodiment of the invention. The activator port 1204 may be associated with a component object 1202. The activator port may both provide resources to a needer port 1112 with an associated component object 1110 and also request resources from a provider port 1104 with an associated component object 1102. Thus, with respect to the provider port 1104, the activator port 1204 is a needer port and with respect to the needer port 1112 the activator port 1204 is a provider port.

According to one embodiment of the invention, an activator port 1202 may have a multiplicative effect on a number of received resources. For instance, an activator port may consume a single resource and provide three of the resource to be consumed. An example may be a backplane which consumes a single disk controller resource and provides three disk controller resources to needer ports for three disk drives. Where an activator port has a multiplicative effect on a number of resources being consumed by the activator port, the activator port may be used to create a connection chain. FIG. 13 is a block diagram depicting a connection tree 1300 which utilizes an activator port 1204. The activator port 1204 may have an associated component object 1202 and may receive a resource from a provider port 1104. The activator port 1204 may then provide three of the resources the three needer ports 1112, 1122, 1132 with three respective component objects 1110, 1120, 1130.

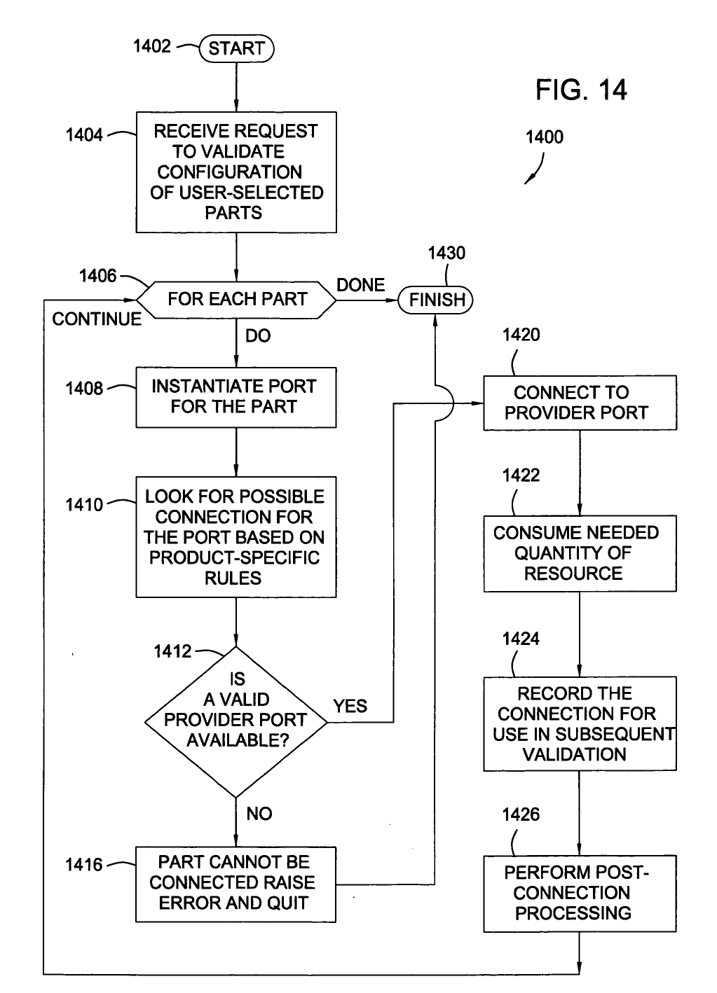

Various aspects of creating connections with needer ports, provider ports, and activator ports are now described with reference to FIGS. 14-16.

Creating Connections With Connection Objects Which Request Resources

FIG. 14 is a flow diagram depicting a process 1400 for creating a connection using a connection requesting object (a needer port or an activator port) according to one embodiment of the invention. The process 1400 may begin at step 1402 and continue to step 1404 where a request to validate a configuration of user selected parts is received. The process may then continue to step 1406 where a loop is entered. The loop may continue for each part in the configured system and may be used to instantiate and validate each part in the system which requires resources for proper validation. Thus, at step 1408 a needer port may be instantiated for the part.

At step 1410, a search for possible connections for the needer port may be performed based on product-specific rules. Searching for possible connections within the system may include accessing a model of the system, determining which component objects are in the system, and then determining which component objects in the system have provider ports or activator ports providing resources. From the available components and ports, the product-specific rules may be used to determine a best connection for the needer port. Even if other, sub-optimal connections are possible, the part-specific rules may be used to test connections to optimal parts before connections to sub-optimal parts are attempted. In one embodiment of the invention, the part-specific rules may be predetermined part rules, provided, for instance, by a manufacturer of the part. In another embodiment of the invention, an applicable rule may be chosen based upon the user-selected configuration of the system. An example of choosing rules based upon system configurations is described in detail commonly-owned U.S. patent application entitled “Method to Establish Contexts for Use During Automated Product Configuration”, filed herewith (Atty Docket ROC920050085US1), which is herein incorporated by reference.

As an example of using product-specific rules to select a best connection, if the component object which the needer port is associated with is a disk drive, the product-specific rules may describe the best connection for that disk drive. For instance, the product-specific rules may provide a part number for a backplane, and the backplane may be rated as the best connection within the rules. To rate the backplane connection, the rules may contain a weight associated with the backplane which describes whether the backplane connection is good or poor relative to other possible connections. The weight associated with the backplane may, for instance, be “1’, which may indicate that the specified backplane is the best choice for connectioning the component object. The backplane, if available in the system model, may be used to connect the component.

Other possible connections for the disk drive may be present in the system model, such as a direct connection to a disk controller. However, the part-specific rules may specify that a direct connection to the disk controller is sub-optimal. For instance, the part-specific rules may specify that the disk controller connection has a weight of 2, indicating that the disk controller connection is the second best choice, i.e., inferior to the first choice, the backplane. Thus, when applying the rules, the backplane may be preferred over the disk controller and an attempt to create a connection to the disk controller may not be made until the possible connection with the backplane is evaluated to determine if the best connection can be made.

In one embodiment, if a best connection is not available, the product-specific rules may be used to insert a part into the system which satisfies the best connection rules. For instance, if the optimal backplane is not available, an object for the backplane may be automatically inserted into the system model using the part number, and the backplane object may then be used to connect the disk drive. The process of instantiating optimal parts and connecting them to each other may be repeated for each inserted part until a chain or tree of optimally connected parts is created, from a part needing a resource to the ultimate part providing the needed resource. Thus, the product-specific rules, when used with port objects, may be used to intelligently and efficiently create connections within the system model. In another embodiment, if a best connection is not available, the product-specific rules may also be used to determine if a second or third best connection is available.

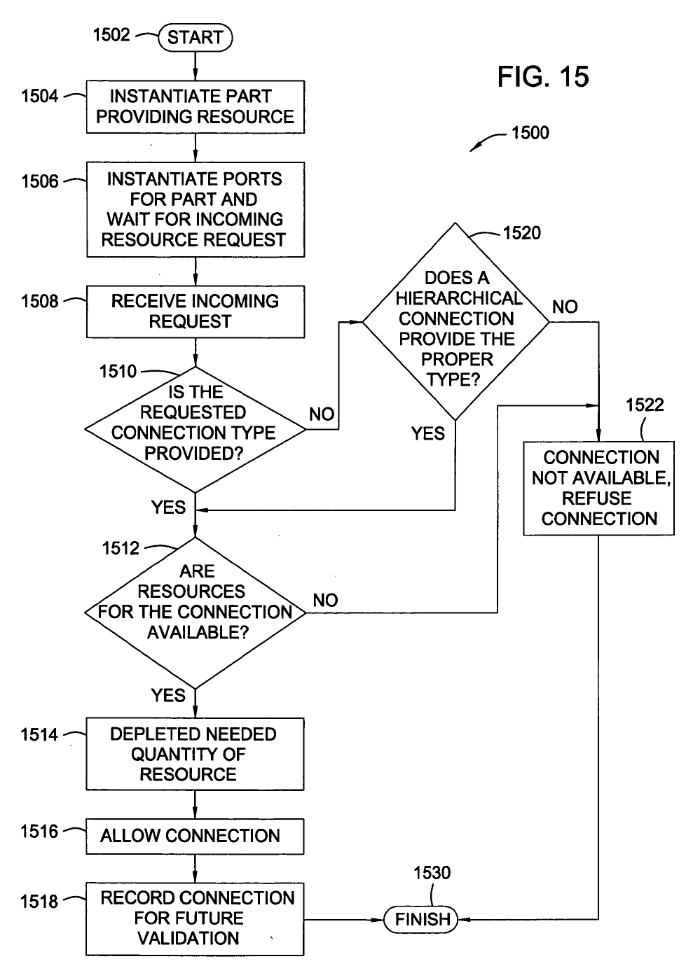

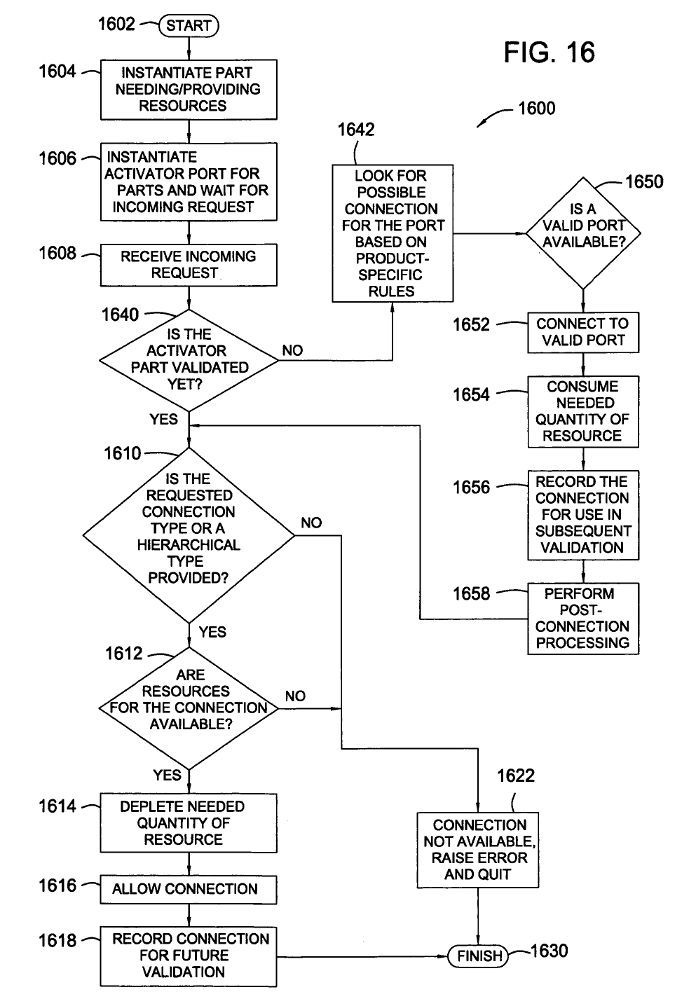

At step 1412, a determination may be made of whether a valid provider port or activator port is available for the needer port. The determination may be performed with respect to each of the possible connections identified using the product-specific rules. Determining whether a port is valid may include determining whether any ports in the system provide one or more resources of the requested type (including a hierarchical type), determining whether a needed quantity of resources is provided by the port, and determining whether the needed quantity of resources is available for consumption. The step 1412 of determining whether a port is available is described in greater detail with respect to FIGS. 15-16 below. If none of the available ports offer a valid connection, the needer port resource needs cannot be satisfied. Thus, according to one embodiment of the invention, the part needing resources cannot be connected, and an error flag may be raised at step 1416. The process 1400 may then finish at step 1430.

In another embodiment of the invention, a part needing resources may accept several types of resources. Thus, if a part needing resources cannot find a first type of resource using a first needer or activator port, the part may use one or more other needer ports or activator ports to search for another acceptable type of resource. Thus, instead of raising an error flag raised when a first type of resource need cannot be satisfied, the process 1400 may continue until a search has been performed for each of the acceptable types of resources.

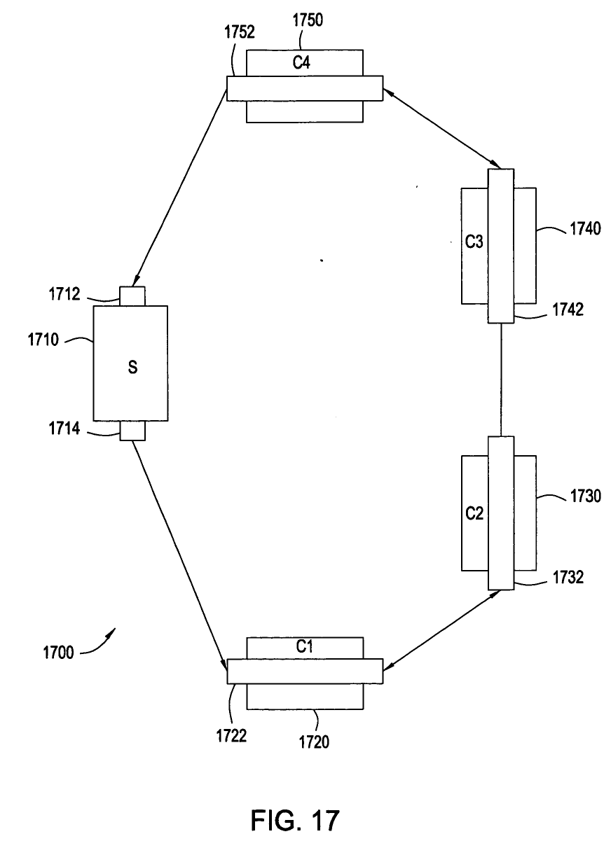

According to one embodiment of the invention, if a valid port providing resources is available, a connection to the port may be created at step 1420. At step 1422, the needer port may consume the needed quantity of resources. The connection may then be recorded by the needer port at step 1424 for use in subsequent validation. Thus, in one embodiment of the invention, a port object may be used to track each of its own connections, without using an external list of connections to determine whether a connection has been made. Subsequent validation steps may apply validation rules to the connection to determine whether the connection of components is valid. For instance, a connection chain or a connection tree may be examined after a connection has been created to determine whether one or more validation rules which apply to the entire chain or tree (and not necessarily a single element in the chain or tree) are satisfied. An example of validation of a connection chain is provided below with respect to FIG. 17.

At step 1426, any necessary post-connection processing may be performed on the needer port. An example of post-connection processing may include initializing one or more variables for use in subsequent validation of the connection. For instance, a variable may be initialized which records the number of connections between the needer port and the end provider port (e.g., the provider port associated with a component object which provides the original resources, such as a disk controller). As another example, a variable may be initialized which describes a part number for the type of cable used to connect the component objects on either side of the connection. Once the post-connection processing has been performed, the process of connecting parts may be continued until the process finishes at step 1430.

In one embodiment of the invention, each component object may have multiple ports (which may include multiple activator ports, provider ports, and needer ports on a single component object). Each needer port on a component object may need a different type of resource. As an example, a disk drive may have an associated needer port which requires a power resource from a power supply and another associated needer port which requires a controller resource from a disk controller. Accordingly, the steps 1408, 1410, 1412, etc., for instantiating and connecting ports for a part may be repeated for each port on a given part.

Creating Connections With Connection Objects Which Provide Resources

FIG. 15 is a flow diagram depicting a process for creating a connection with a connection providing object (a provider port or an activator port) according to one embodiment of the invention. The process 1500 may begin at step 1502 and continue to step 1504 where a part which provides one or more resources is instantiated. At step 1506, provider ports for the part may be instantiated and the instantiated provider ports may wait for incoming resource requests from needer ports or activator ports. An incoming connection request may be received at step 1508, and at step 1510, a determination may be made as to whether the requested connection type is provided. The determination may be made by determining whether the requested resource type directly matches the provided resource type.

If a requested connection type is not provided, a determination may be made as to whether an acceptable hierarchical connection type is provided. A hierarchical connection may be acceptable if the provider port provides a resource which hierarchically matches the resource being requested (described in detail above). If no acceptable connection is provided, the connection may be refused at step 1522 and the process 1500 may finish at step 1530.

If a proper connection type is provided by the provider port, a determination may be made at step 1512 of whether a requested number of resources is available. If the requested number of resources is unavailable, the connection may be refused at step 1522 and the process 1500 may finish at step 1530. If the requested number of resources is available, the requested number of resources may be depleted at step 1514, and the connection may be allowed at step 1516. The connection may then be recorded for use in future validation at step 1518, and the process 1500 may finish at step 1530.

Creating Connections With Connection Objects Providing and Requesting Resources

FIG. 16 is a flow diagram depicting a process for creating a connection with a connection object which both requests resources and provides resources (an activator port) according to one embodiment of the invention. The process 1600 may begin at step 1602 and continue to step 1604 where a part which provides one or more resources and needs one or more resources is instantiated. At step 1606, an activator port for the part may be instantiated, and the instantiated activator port may wait for incoming needer port or activator port requests. An incoming connection request may be received at step 1608.

At step 1640 a determination may be made as to whether the activator port has been validated. An activator port which is not validated may not be connected to any other ports. As such, an unconnected activator port may have no resources to provide for incoming requests. In one embodiment, an activator port may be validated when an incoming request is received. For instance, if a needer port previously utilized product-specific rules (described above) to insert a new part and associated activator port into the system model, the subsequent request from the needer port may cause the activator port to validate itself. In another embodiment of the invention, an activator port may be validated when the activator port is instantiated, but before an incoming request is received.

If the activator port has not been validated, the activator port may take on the role of a needer port. Thus, at step 1642, a search for possible connections for the activator port may be performed based on product-specific rules. Searching for possible connections within the system is described above in detail with respect to needer ports. As before, if a best connection is not available, the product-specific rules may be used to insert a part into the system which satisfies the best connection rules. The process of instantiating optimal parts and connecting them to each other may be repeated for each inserted part until a chain or tree of optimally connected parts is created.

At step 1650, a determination may be made of whether a valid provider port or activator port providing resources is available for the activator port. If none of the available provider ports offer a valid connection, the activator port resource needs cannot be satisfied. Thus, according to one embodiment of the invention, the part with the activator port cannot be connected, and an error flag may be raised at step 1622. The process may then finish at step 1630.

If a valid port is available for the activator port, a connection to the valid port may be created at step 1652, and at step 1654, the activator port may consume the needed quantity of resources. The connection may then be recorded by the activator port at step 1656 for use in post-connection processing. At step 1658, any post-connection processing for the activator port may be performed.

If the activator port is validated, the process 1600 may continue at step 1610 where a determination may be made as to whether the requested connection type or a valid hierarchical type of connection is provided by the activator port. If no acceptable connection is provided, the connection may be refused at step 1622, and the process 1600 may finish at step 1630. If a proper connection type is provided, a determination may be made at step 1612 of whether a requested number of resources is available. If the requested number of resources is unavailable, the connection may be refused at step 1622, and the process 1600 may finish at step 1630. If the requested number of resources is available, the requested number of resources may be depleted at step 1614, and the connection may be allowed at step 1616. The connection may then be recorded for future validation at step 1618 and the process 1600 may finish at step 1630.

Subsequent Validation of a Connection

As described above, after a connection between two port objects has been created, the connection may be recorded by each port object and post-connection processing may be performed for each port. The recorded connection and the post-connection processing may be used during subsequent validation of the system model. As an example, for system model which represents a network of computers, the recorded connections and/or post-connection processing results may be used to validate the network of computers.

FIG. 17 is a block diagram depicting a model of a network 1700 of computers connected with connection objects according to one embodiment of the invention. As illustrated, the network of computers 1700 may be connected in a loop. One of the objects in the network model may be a server object 1710. The server object 1710 may have a provider port 1714 which provides a resource to the network 1700 and a needer port 1712 which needs a resource from the network 1700. Each of the other computer objects 1720, 1730, 1740, 1750 in the network 1700 may have a respective activator port 1722, 1732, 1742, 1752 which may be used to manage incoming and outgoing connections for each of the computers.

In one embodiment of the invention, each activator port 1722, 1732, 1742, 1752 may record each of its connections as described above. After a new computer object (e.g., computer object 1750) is added to the model, a validation rule may then be applied to determine if the network 1700 is validly connected. For instance, while each individual connection may be valid, a separate validation rule may specify that no more than three computers may be connected in a row. Because the port objects 1722, 1732, 1742, 1752 have a record of which other ports they are connected to, the port objects 1722, 1732, 1742, 1752 may be used by the validator 204 to validate the network. For instance, the validator 204 may query the activator port 1752 for its connections. The activator port 1752 may provide the recorded connections, one to needer port 1712 and one to activator port 1742. Going around the network 1700, the validator 204 may determine that activator port 1742 is connected to activator port 1732 and that activator port 1732 is connected to activator port 1722. In such case, because more than three ports in a row are connected to each other, the validation rule is violated, and the validator 204 may accordingly find the system invalid.

According to another embodiment of the invention, post-connection processing of each port object may be used to generate information which is used in applying subsequent validation rules. For instance, the post-connection processing may be used to store a value in each activator port 1722, 1732, 1742, 1752 which represents the number of connected parts between the activator port and a provider port 1714 providing the original resource from the server object 1710. Thus, for activator port 1722, the value would be zero because there are no connected parts between activator port 1722 and provider port 1714. For activator port 1732, the value would be one because there is one connected object 1720 between activator port 1732 and provider port 1714. By examining the recorded value for activator port 1742 and activator port 1752, the validator 204 may determine that more than three computer objects in the network 1700 were connected in a row and that the network configuration was thus invalid.

While the foregoing is directed to embodiments of the present invention, other and further embodiments of the invention may be devised without departing from the basic scope thereof, and the scope thereof is determined by the claims that follow.

What is claimed is:

1. A method of representing connections in a computer system:
instantiating a component object representing a component in the computer system;
instantiating a connection requesting object representing a connection to the component;
requesting a type of resource for the component object, wherein the connection requesting object transmits the request to a connection providing object, the connection object providing two or more resources;
determining if one of the provided two or more resources is of a same type of resource as the requested type of resource and if the respective one of the provided two or more resources is available for consumption; and
if the respective one of the provided two or more resources is of the same type of resource and is available for consumption, consuming the respective one of the two or more resources and creating the connection.

2. The method of claim 1, wherein the connection providing object provides a connection to a component object representing another component in the system.

3. The method of claim 1, further comprising recording the connection in the connection requesting object, wherein the recorded connection is used during a later validation of the computer system.

4. The method of claim 1 wherein determining if one of the two or more resources is of the same type of resource as the requested type of resource comprises:
determining if the same type of resource specifically matches the requested type of resource;
if not, determining if a hierarchical type of resource from which the same type of resource is derived specifically matches a hierarchical type of resource from which the requested type of resource is derived.

5. The method of claim 1, further comprising applying one or more rules to the connection requesting object before the connection has been created, wherein the one or more rules determine whether the connection is an optimal connection for the component object.

6. The method of claim 1 wherein the connection providing object is a first connection providing object and wherein the first connection providing object transmits a request to a second connection providing object, and wherein the first connection providing object provides a multiple number of resources provided by the second connection providing object.

7. The method of claim 1 wherein the connection providing object is a first connection providing object and wherein the first connection providing object transmits a request to a second connection providing object for another type of resource, and wherein the other type of resource requested by the first connection providing object is different from the type of resource requested by the connection requesting object.

8. A computer-readable medium containing a program which, when executed, performs operations, the operations comprising:
instantiating a component object representing a component in a computer system;
instantiating a connection requesting object representing a connection to the component;
requesting a type of resource for the component object, wherein the connection requesting object transmits the request to a connection providing object, the connection object providing two or more resources;
determining if one of the provided two or more resources is of a same type of resource as the requested type of resource and if the respective one of the provided two or more resources is available for consumption; and
if the respective one of the provided two or more resources is of the same type of resource and is available for consumption, consuming the respective one of the two or more resources and creating the connection.

9. The computer-readable medium of claim 8, wherein the connection providing object provides a connection to a component object representing another component in the system.

10. The computer-readable medium of claim 8, further comprising recording the connection in the connection requesting object, wherein the recorded connection is used during a later validation of the computer system.

11. The computer-readable medium of claim 8, wherein determining if one of the two or more resources is of the same type of resource as the requested type of resource comprises:
determining if the same type of resource specifically matches the requested type of resource;
if not, determining if a hierarchical type of resource from which the same type of resource is derived specifically matches a hierarchical type of resource from which the requested type of resource is derived.

12. The computer-readable medium of claim 8, further comprising applying one or more rules to the connection requesting object before the connection has been created, wherein the one or more rules determine whether the connection is an optimal connection for the component object.

13. The computer-readable medium of claim 8, wherein the connection providing object is a first connection providing object and wherein the first connection providing object transmits a request to a second connection providing object, and wherein the first connection providing object provides a multiple number of resources provided by the second connection providing object.

14. The computer-readable medium of claim 8, wherein the connection providing object is a first connection providing object and wherein the first connection providing object transmits a request to a second connection providing object for another type of resource, and wherein the other type of resource requested by the first connection providing object is different from the type of resource requested by the connection requesting object.

15. A system, comprising:
a processor; and
a storage media containing a program, the program when executed by the processor performing the steps comprising:
instantiating a component object representing a component in a computer system;
instantiating a connection requesting object representing a connection to the component;
requesting a type of resource for the component object, wherein the connection requesting object transmits the request to a connection providing object, the connection object providing two or more resources;
determining if one of the provided two or more resources is of a same type of resource as the requested type of resource and if the respective one of the provided two or more resources is available for consumption; and
if the respective one of the provided two or more resources is of the same type of resource and is available for consumption, consuming the respective one of the two or more resources and creating the connection.

16. The system of claim 15, wherein the connection providing object provides a connection to a component object representing another component in the system.

17. The system of claim 15, further comprising recording the connection in the connection requesting object, wherein the recorded connection is used during a later validation of the computer system.

18. The system of claim 15, wherein determining if one of the two or more resources is of the same type of resource as the requested type of resource comprises:
determining if the same type of resource specifically matches the requested type of resource;
if not, determining if a hierarchical type of resource from which the same type of resource is derived specifically matches a hierarchical type of resource from which the requested type of resource is derived.

19. The system of claim 15, further comprising applying one or more rules to the connection requesting object before the connection has been created, wherein the one or more rules determine whether the connection is an optimal connection for the component object.

20. The system of claim 15, wherein the connection providing object is a first connection providing object and wherein the first connection providing object transmits a request to a second connection providing object, and wherein the first connection providing object provides a multiple number of resources provided by the second connection providing object.

21. The system of claim 15, wherein the connection providing object is a first connection providing object and wherein the first connection providing object transmits a request to a second connection providing object for another type of resource, and wherein the other type of resource requested by the first connection providing object is different from the type of resource requested by the connection requesting object.
